(19) United States
(12) Patent Application Publication
(10) Pub. No.: US 2026/0214483 A1
(43) Pub. Date: Jul. 23, 2026

(54) CROSS LINK INTERFERENCE MEASUREMENT METHOD AND APPARATUS

(71) Applicant: BEIJING UNISOC COMMUNICATIONS TECHNOLOGY CO., LTD., Beijing (CN)

(72) Inventor: Ling ZHAO, Beijing (CN)

(21) Appl. No.: 18/870,604

(22) PCT Filed: May 30, 2023
(86) PCT No.: PCT/CN2023/096998

§ 371 Date: Nov. 29, 2024

(30) Foreign Application Priority Data
May 30, 2022 (CN) 202210600614.8

(51) Int. Cl. H04W 24/10; H04B 7/06; H04B 17/318; H04B 17/345

(52) U.S. Cl. CPC H04W 24/10; H04B 7/0626; H04B 17/318; H04B 17/345

(57) ABSTRACT

A cross link interference measurement method and apparatus is provided. The method includes: receiving CLI measurement configuration information, where the CLI measurement configuration information is contained in channel state information (CSI) resource configuration information, and the CLI measurement configuration information includes CLI resource configuration information and CLI measurement report configuration information; performing CLI measurement on a resource configured through the CLI resource configuration information, according to the CLI measurement report configuration information; and transmitting a CLI measurement report.

### CROSS-REFERENCE TO RELATED APPLICATION(S)

This application is a National Stage of International Application No. PCT/CN 2023/096998, field May 30, 2023, which claims priority to Chinese Patent Application No. 202210600614.8, filed May 30, 2022, both of which are incorporated herein by reference herein.

### TECHNICAL FIELD

This disclosure relates to the field of communication technology, in particular to a cross link interference measurement method and apparatus.

### BACKGROUND

With the rapid growth of uplink service demand, higher demands are put forward for uplink coverage, data transmission rate, and delay. In full-duplex technology, uplink transmission and downlink transmission occur at the same time, which provides an opportunity for enhancing uplink services. As an important topic of R18, the duplex enhancement topic will study subband full-duplex on a base station side. On the base station side, by utilizing subbands, the frequency domain is divided for uplink transmission and downlink transmission, and frequency division can reduce the interference and reduce the complexity of the base station while ensuring simultaneous occurrence of uplink transmission and downlink transmission.

For subband full-duplex, frequency domain resources are divided into different subbands on the base station side, and downlink transmission and uplink reception are performed in different subbands at the same time. However, for a user equipment (UE), half-duplex is still supported, in other words, at a certain time point, only downlink reception can be performed in the downlink subband or only uplink transmission can be performed in the uplink subband. This will introduce base station-to-base station (gNB-to-gNB) and UE-to-UE cross link interference (CLI), where inter subband CLI is a newly introduced CLI in subband full-duplex. The gNB-to-gNB inter subband CLI is an interference of a transmission signal in the downlink subband of one base station to reception in the uplink subband of another base station. The UE-to-UE inter subband CLI is an interference of a transmission signal in the uplink subband of one UE and reception in the downlink subband of another UE.

In subband full-duplex, the configurations of subbands can change dynamically, so interference source resources to-be-tested at different times are also different. Thus, the periodic long-term CLI measurement defined in R16 and transmission of the L3 based-CLI measurement result will not meet the demands of dynamically-changed subbands. The transmission of the L3 based-CLI measurement result has a long delay, which cannot effectively track dynamic configurations of subbands in subband full-duplex.

### SUMMARY

Embodiments of the disclosure provide a cross link interference (CLI) measurement method. The method includes: receiving CLI measurement configuration information, where the CLI measurement configuration information is contained in CSI resource configuration information, and the CLI measurement configuration information includes CLI resource configuration information and CLI measurement report configuration information; performing CLI measurement on a resource configured through the CLI resource configuration information, according to the CLI measurement report configuration information; and transmitting a CLI measurement report.

Embodiments of the disclosure further provide another CLI measurement method. The CLI measurement method includes: generating CLI measurement configuration information, where the CLI measurement configuration information is contained in CSI resource configuration information, and the CLI measurement configuration information includes CLI resource configuration information and CLI measurement report configuration information; and transmitting the CLI measurement configuration information.

Embodiments of the disclosure further provide a cross link interference measurement apparatus. The apparatus includes a transceiver, a memory, and a processor. The memory stores computer programs. The processor is coupled with the memory and the transceiver and is configured to invoke the computer programs to: cause the transceiver to receive CLI measurement configuration information, where the CLI measurement configuration information includes CLI resource configuration information and CLI measurement report configuration information and the CLI measurement report configuration information is contained in a CSI measurement report configuration; perform CLI measurement on a resource configured through the CLI resource configuration information, according to the CLI measurement report configuration information; and cause the transceiver to transmit a CLI measurement report.

### BRIEF DESCRIPTION OF THE DRAWINGS

FIG. 1 is a flowchart of a cross link interference measurement method according to embodiments of the disclosure.

FIG. 2 is a flowchart of another cross link interference measurement method according to embodiments of the disclosure.

FIG. 3 is a schematic structural diagram of a cross link interference measurement apparatus according to embodiments of the disclosure.

FIG. 4 is a schematic structural diagram of another cross link interference measurement apparatus according to embodiments of the disclosure.

FIG. 5 is a schematic structural diagram of yet another cross link interference measurement apparatus according to embodiments of the disclosure.

### DETAILED DESCRIPTION

In the current protocol, for the periodic cross link interference (CLI) measurement, the periodic measurement resources are configured through radio resource control (RRC) signaling, and the measurement is performed on the configured measurement resources. The reporting mechanism of the CLI measurement result is layer 3-based reporting, which has a long delay and cannot effectively track the dynamic subband configuration in subband full-duplex.

In embodiments of the disclosure, since the CLI measurement configuration information is contained in the CSI resource configuration information, the obtained CLI measurement report can be contained in a CSI report. Upon transmission of the CSI report, the CLI measurement report can be transmitted. By transmitting the CSI report via the physical layer, the CLI measurement report can be transmitted via the physical layer. Thus, the transmission delay of the CLI measurement report can be effectively reduced, and the dynamic subband configuration in the subband full-duplex can be effectively tracked.

For more clear understanding of the above objects, features, and advantageous effects of the disclosure, specific embodiments of the disclosure will be described in detail below with reference to accompanying drawings.

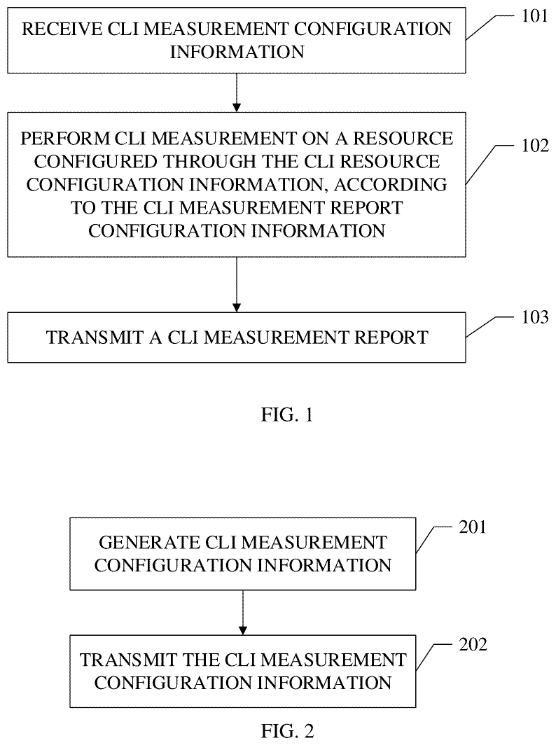

Embodiments of the disclosure provide a cross link interference measurement method. The method is described in detail in terms of specific steps below with reference to FIG. 1.

The user equipment described in the embodiment of the disclosure is a device having a wireless communication function, and can also be referred to as a terminal, a mobile station (MS), a mobile terminal (MT), an access user equipment, a vehicle-mounted user equipment, an industrial control user equipment, a user equipment (UE) unit, a UE station, a mobile radio station, a remote station, a remote user equipment, a mobile device, a wireless communication device, a UE agent, or a UE device. The UE can be fixed or mobile. The UE can support at least one wireless communication technology such as LTE, NR, and the like. For example, the UE can be a mobile phone, a tablet, a desktop, a laptop, an all-in-one machine, a vehicle terminal, a virtual reality (VR) UE, an augmented reality (AR) UE, a wireless terminal in industrial control, a wireless terminal in self driving, a wireless terminal in remote medical surgery, a wireless terminal in smart grid, a wireless terminal in transportation safety, a wireless terminal in smart city, a wireless terminal in smart home, a cellular phone, a cordless phone, a session initiation protocol (SIP) telephone, a wireless local loop (WLL) station, a personal digital assistant (PDA), a handheld device or computing device with a wireless communication capability, or other processing devices connected to a wireless modem, a wearable device, a UE in a future mobile communication network, or a UE in a future evolved public land mobile network (PLMN), etc. In some embodiments of the disclosure, the UE can also be a device having a transceiver function, such as a chip system. The chip system can include a chip and can also include other discrete devices.

In embodiments of the disclosure, the network device is a device that provides a wireless communication function for the user equipment, and can also be referred to as a radio access network (RAN) device, an access network element, an access network device, or the like. The network device can support at least one wireless communication technology, such as LTE, NR, etc. For example, network devices include, but are not limited to, a next generation node B (gNB) in 5G, an evolved node B (eNB), a radio network controller (RNC), a node B (NB), a base station controller (BSC), a base transceiver station (BTS), a home base station (e.g., home evolved node B, or home node B, HNB), a baseband unit (BBU), a transmitting and receiving point (TRP), a transmitting point (TP), a mobile switching center, and the like. The network device can also be a wireless controller, a centralized unit (CU), and/or a distributed unit (DU) in a cloud radio access network (CRAN) scenario, or the network device can be a relay station, an access point, an in-vehicle device, a user equipment, a wearable device, a network device in future mobile communication, a network device in future evolution PLMN, or the like. In some embodiments, the network device can also be an apparatus, such as a chip system, having the function of providing wireless communication for the user equipment. For example, the chip system can include a chip and can also include other discrete devices.

In some embodiments, the network device can also communicate with an Internet protocol (IP) network, such as the Internet, a private IP network, or other data network, etc.

In a specific implementation, the cross link interference measurement method described in the following steps 101 to 103 can be executed by a chip with a data processing function in a user equipment, or can be executed by a chip module including the chip with the data processing function in the user equipment.

Step 101, CLI measurement configuration information is received.

Step 102, according to the CLI measurement report configuration information, CLI measurement is performed on a resource configured through the CLI resource configuration information.

In a specific implementation, after channel state information (CSI) resource configuration information is received, CLI resource configuration information and CLI measurement report configuration information can be obtained from the CSI resource configuration information.

In the prior art, in the CSI resource configuration information (ResourceConfig), a measurement resource set list (nzp-CSI-RS-ResourceSetList) for nzp-CSI-RS, a measurement resource set list (csi-SSB-ResourceSetList) for csi-SSB, and a measurement resource set list (csi-IM-ResourceSetList) for csi-IM are defined.

In embodiments of the disclosure, the existing CSI resource configuration information is improved, in other words, in addition to the above three measurement resource sets, the CSI resource configuration information includes the CLI measurement configuration information, where the CLI measurement configuration information can include the CLI resource configuration information and the CLI measurement report configuration information.

In a specific implementation, the CLI resource configuration information can include multiple CLI measurement candidate-resource-set lists and candidate-resource-set list indication information, where the candidate-resource-set list indication information indicates a candidate-resource-set list for CLI measurement.

In embodiments of the disclosure, csi-CLI-ResourceSetList (that is, the above-described multiple CLI measurement candidate-resource-set lists) can be added to the CSI resource configuration information.

In a specific implementation, the csi-CLI-ResourceSetList can be contained in the nzp-CSI-RS-ResourceSetList (nzp-CSI-RS measurement resource set list) or can be independent of the nzp-CSI-RS-ResourceSetList.

The existing CSI-ReportConfig includes information elements (IE) for channel measurement resources, CSI-IM resources for interference (csi-IM-ResourcesForInterference), and nzp-CSI-RS resources for interference (nzp-CSI-RS-ResourcesForInterference), where the measurement resources are associated with corresponding resource indexes (CSI-ResourceConfigId).

In embodiments of the disclosure, an information element is added to the CSI-ReportConfig, and the information element can represent an association relationship between the CLI measurement candidate-resource-set lists and the candidate-resource-set list indication information (CSI-ResourceConfigId).

That is, in embodiments of the disclosure, the CLI resource configuration information can include the multiple CLI measurement candidate-resource-set lists (csi-CLI-ResourceSetList) and the candidate-resource-set list indication information (CSI-ResourceConfigId).

In a specific implementation, the user equipment can perform CLI measurement on the resource configured through the CLI resource configuration information, according to the CLI measurement report configuration information.

In embodiments of the disclosure, for periodic transmission, each candidate-resource-set list corresponds to one candidate-resource-set, and according to the candidate-resource-set list indication information, which candidate-resource-set list is selected to perform CLI measurement can be determined. Since one candidate-resource-set list corresponds to one candidate-resource-set, when the candidate-resource-set list for CLI measurement is determined, the candidate-resource-set for CLI measurement is also determined.

In this case, CLI measurement can be performed on the determined candidate-resource-set according to the CLI measurement report configuration information.

For aperiodic transmission, the number of candidate-resource-sets in one CLI measurement candidate-resource-set list can be multiple, that is, one CLI measurement candidate-resource-set list includes multiple candidate-resource-sets.

Therefore, in embodiments of the disclosure, the CLI resource configuration information can further include candidate-resource-set indication information, where the candidate-resource-set indication information can indicate a candidate-resource-set for CLI measurement in the determined candidate-resource-set list in aperiodic transmission.

In CSI-AssociatedReportConfigInfo, an information element is added to indicate the candidate-resource-set for CLI measurement. The trigger status is associated with the CSI report through the newly added information element.

In embodiments of the disclosure, the newly added information element in the CSI-AssociatedReportConfigInfo is the candidate-resource-set indication information described above.

In a specific implementation, according to the information element (csi-CLI-ResourcesForInterference), one candidate-resource-set (resource set) in the candidate-resource-set list (csi-CLI-ResourceSetList) is selected for measurement. The value of csi-CLI-ResourcesForInterference ranges from 1 to maxNrofcsi-CLI-ResourceSetsPerConfig, where maxNrofcsi-CLI-ResourceSetsPerConfig represents the largest number of candidate-resource-sets used for CLI measurement in each candidate-resource-set list.

In a specific implementation, the CLI measurement candidate-resource-set list and the candidate-resource-set list indication information can be transmitted by the network device through RRC signaling. The CLI measurement candidate-resource-set list can be transmitted by the network device through RRC signaling and the candidate-resource-set indication information can be transmitted by the network device through DCI.

In embodiments of the disclosure, the CLI measurement report configuration information can include a CLI reference signal received power (RSRP), or include a CLI received signal strength indicator (RSSI), or include both the CLI RSRP and the CLI RSSI.

In embodiments of the disclosure, the CLI measurement report configuration information can be contained in the CSI-ReportConfig. Specifically, the CLI measurement report configuration information can be contained in reportQuantity in CSI-ReportConfig.

In a specific implementation, the specific process of CLI measurement performed by the user equipment can refer to the existing protocol, and embodiments of the disclosure will not be described in detail.

Step 103, a CLI measurement report is transmitted.

In a specific implementation, after a CLI measurement result is obtained, the corresponding CLI measurement report can be generated according to the CLI measurement result, and the obtained CLI measurement report can be transmitted to the network device.

In embodiments of the disclosure, the CLI measurement report can be contained in the CSI report. Thus, when the CSI report is transmitted to the network device, the CLI measurement report is transmitted to the network device.

In embodiments of the disclosure, the CSI report can be transmitted via a physical layer (layer 1). Thus, the CLI measurement report is transmitted to the network device via the physical layer (layer 1). The CLI measurement report is transmitted through layer 1, so that the network device can obtain the CLI measurement report only through decoding at the physical layer.

In the prior art, the CLI measurement report is transmitted through a RRC layer (layer 3), so the CLI measurement report can be obtained through decoding at the physical layer, decoding at a mac layer, and decoding at the RRC layer.

As can be seen that, compared to transmitting the CLI measurement report through layer 3, transmitting the CLI measurement report through layer 1 can greatly reduce the delay required for transmitting the CLI measurement report, and effectively track the dynamic subband configuration in the subband full-duplex.

In a specific implementation, the CSI report can also carry a CSI measurement report and a CQI measurement report, and the CSI measurement report includes an RSRP or a signal to interference plus noise ratio (SINR).

Therefore, in the CSI report, the CLI measurement report may collide with the CSI measurement report and/or the CQI measurement report. When the collision occurs, whether to transmit the CLI measurement report can be determined according to a priority of the CLI measurement report and a priority of the CSI measurement report and/or a priority of the CQI measurement report.

In embodiments of the disclosure, the priority of the CLI measurement report can be set by the user equipment. The priority of the CLI measurement report can also be determined by the network device and issued by the network device. The user equipment can receive the priority of the CLI measurement report issued by the network device.

In a specific implementation, the network device can issue the priority of the CLI measurement report through higher layer signaling (such as RRC signaling, MAC CE, etc.), or can issue the priority of the CLI measurement report through downlink control information (DCI).

In a specific implementation, the user equipment can determine that in the CSI report, the priority of the CSI measurement report is the highest, the priority of the CQI measurement report is the second highest, and the priority of the CLI measurement report is the lowest. In this case, if the CLI measurement report collides with any one of the CSI measurement report and the CQI measurement report, the CLI measurement report needs to be dropped, that is, the CLI measurement report is not transmitted.

Alternatively, the user equipment can determine that in the CSI report, the priority of the CSI measurement report is the highest, the priority of the CLI measurement report is the second highest, and the priority of the CQI measurement report is the lowest. In this case, if the CLI measurement report collides with the CQI measurement report, the CQI measurement report needs to be dropped, that is, the CQI measurement report is not transmitted.

According to the prior art, the Pri value of the priority of the i-th CSI report is defined as Pri_iCSI (y, k, c, s)=2·N_cells·M_s·y+N_cells·M_s·k+M_s·c+s, where y=0, 1, 2, and 3 respectively indicate that the type of the channel carrying the CSI report and the time-domain periodicity of the CSI report are: PUSCH and aperiodic, PUSCH and semi-persistent, PUCCH and semi-persistent, and PUCCH and periodic, respectively, and k=0, 1 respectively indicate that the content of the CSI report includes RSRP/SINR or CQI; c represents the ID of the serving cell corresponding to the reference signal corresponding to the CSI report, and s denotes the ID of the CSI report. The smaller the Pri value of the priority of the CSI report, the higher the corresponding priority.

It can be seen that in the prior art, k=0 is for transmission of the CSI measurement report, and k=1 is for transmission of the CQI measurement report, where the priority of the CSI measurement report is higher than the priority of the CQI measurement report.

In embodiments of the disclosure, k in the above formula regarding priority can be extended, in other words, k=2 indicates transmission of the CLI measurement report, that is, the priority of the CLI measurement report is lower than the priority of the CQI measurement report.

Alternatively, k=1 indicates transmission of the CLI measurement report, and k=2 indicates transmission of the CQI measurement report, that is, the priority of the CLI measurement report is higher than the priority of the CQI measurement report and lower than the priority of the CSI measurement report.

In conclusion, in embodiments of the disclosure, since the CLI measurement configuration information is contained in the CSI resource configuration information, the obtained CLI measurement report can be contained in a CSI report. Upon transmission of the CSI report, the CLI measurement report can be transmitted. By transmitting the CSI report via the physical layer, the CLI measurement report can be transmitted via the physical layer. Thus, the transmission delay of the CLI measurement report can be effectively reduced, and the dynamic subband configuration in the subband full-duplex can be effectively tracked.

FIG. 2 illustrates another cross link interference CLI measurement method according to embodiments of the disclosure, which will be described in detail below with specific steps.

In a specific implementation, the cross link interference measurement method described in the following steps 201 to 202 can be executed by a chip with a data processing function in a network device, or can be executed by a chip module including the chip with the data processing function in the network device.

Step 201, CLI measurement configuration information is generated.

In embodiments of the disclosure, the CLI measurement configuration information can include multiple CLI measurement candidate-resource-set lists and candidate-resource-set list indication information, where the candidate-resource-set list indication information indicates a candidate-resource-set list for CLI measurement.

In embodiments of the disclosure, the CLI measurement configuration information can further include the CLI measurement candidate-resource-set list and candidate-resource-set indication information. The candidate-resource-set indication information indicates a candidate-resource-set for CLI measurement in aperiodic transmission in the candidate-resource-set list.

In embodiments of the disclosure, the CLI measurement report configuration information can be contained in a CSI measurement report configuration. The CLI measurement report configuration information can include CLI reference signal received power, or include CLI received signal strength indicator, or include both the CLI reference signal received power and the CLI received signal strength indicator.

In a specific implementation, the related content of the CLI measurement configuration information can be referred to the embodiments corresponding to the above steps 101 to 103.

Step 202, CLI measurement configuration information is transmitted.

In a specific implementation, the network device can transmit the generated CLI measurement configuration information to a user equipment. After receiving the CLI measurement configuration information, the user equipment can execute the above steps 101 to 103.

In a specific implementation, the network device can receive a CLI measurement report reported by the user equipment via a physical layer.

In a specific implementation, the network device can pre-configure a priority of the CLI measurement report and transmit the priority of the CLI measurement report to the user equipment.

In embodiments of the disclosure, the network device can configure that: in a CSI report, a CSI measurement report has the highest priority, a CQI measurement report has the second highest priority, and the CLI measurement report has the lowest priority. Alternatively, the network device can configure that: in the CSI report, the CSI measurement report has the highest priority, the CLI measurement report has the second highest priority, and the CQI measurement report has the lowest priority.

In conclusion, it can be seen that in embodiments of the disclosure, the network device configures the CSI resource configuration information to carry the CLI measurement configuration information. The user equipment performs corresponding CLI measurement according to the CLI measurement configuration information, and transmits the CLI measurement report, where the CLI measurement report can be contained in the CSI report. When the CSI report is transmitted, the CLI measurement report can be transmitted. By transmitting the CSI report via the physical layer, the CLI measurement report can be transmitted via the physical layer. Thus, the transmission delay of the CLI measurement report can be effectively reduced, and the dynamic subband configuration in the subband full-duplex can be effectively tracked.

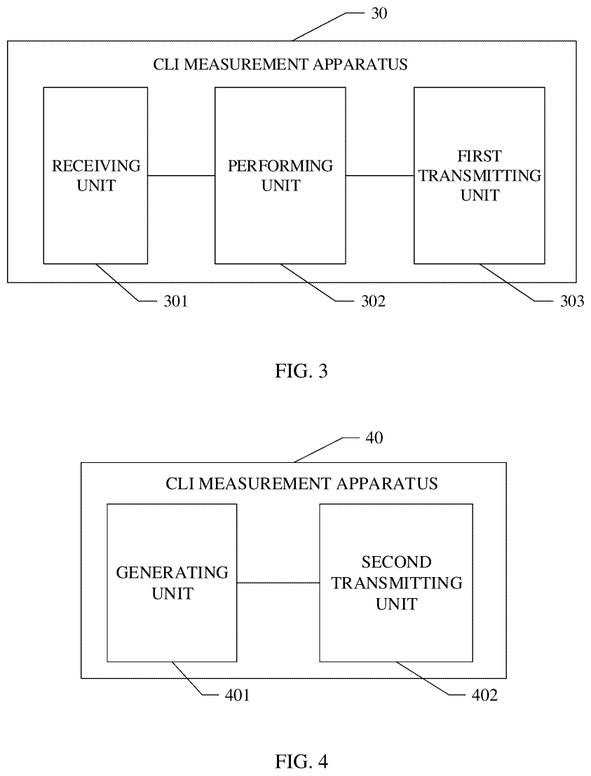

FIG. 3 illustrates a cross link interference measurement apparatus 30 according to embodiments of the disclosure. The cross link interference measurement apparatus 30 includes a receiving unit 301, a performing unit 302, and a first transmitting unit 303.

The receiving unit 301 is configured to receive CLI measurement configuration information, where the CLI measurement configuration information is contained in CSI resource configuration information, and the CLI measurement configuration information includes CLI resource configuration information and CLI measurement report configuration information. The performing unit 302 is configured to perform CLI measurement on a resource configured through the CLI resource configuration information according to the CLI measurement report configuration information. The first transmitting unit 303 is configured to transmit a CLI measurement report.

In the specific implementation, the specific execution processes of the receiving unit 301, the performing unit 302, and the first transmitting unit 303 can refer to the above steps 101 to 103, and will not be repeated herein.

In a specific implementation, the above-described cross link interference measurement apparatus 30 can correspond to a chip (such as a baseband chip) with a data processing function in a user equipment, or a chip module including the chip with the data processing function in the user equipment, or the user equipment.

FIG. 4 illustrates another cross link interference measurement apparatus 40 according to embodiments of the disclosure. The cross link interference measurement apparatus 40 includes a generating unit 401 and a second transmitting unit 402.

The generating unit 401 is configured to generate CLI measurement configuration information, where the CLI measurement configuration information is contained in CSI resource configuration information, and the CLI measurement configuration information includes CLI resource configuration information and CLI measurement report configuration information. The second transmitting unit 402 is configured to transmit the CLI measurement configuration information.

In a specific implementation, the specific execution processes of the generating unit 401 and the second transmitting unit 402 can correspond to steps 201 to 202, and will not be repeatedly described herein.

In a specific implementation, the above-described cross link interference measurement apparatus 40 can correspond to a chip with a data processing function in a network device, or a chip module including the chip with the data processing function in the network device, or the network device.

In a specific implementation, the above can correspond to a chip, such as a baseband chip, with a data processing function in the user equipment, correspond to a chip module including the chip (such as a baseband chip) with the data processing function in the user equipment, or correspond to the user equipment.

In a specific implementation, each module/unit contained in each device or product described in the above embodiment can be a software module/unit, a hardware module/unit, or can be partially a software module/unit, or partially a hardware module/unit.

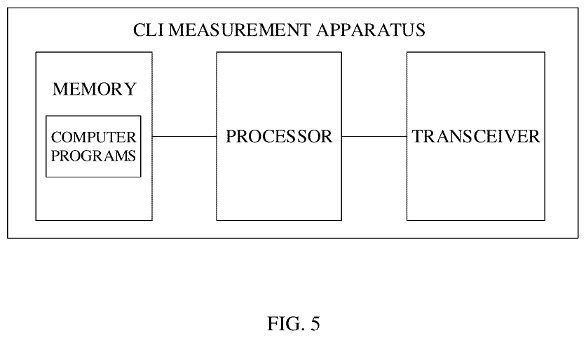

FIG. 5 is a schematic structural diagram of yet another cross link interference measurement apparatus according to embodiments of the disclosure. The apparatus includes a transceiver, a memory, and a processor. The memory stores computer programs. The processor is coupled with the memory and the transceiver and is configured to invoke the computer programs to execute steps of any of the above methods.

For example, for each device or product applied to or integrated into a chip, each module/unit included therein can be implemented in hardware such as circuits, or at least some modules/units can be implemented in a software program running on a processor integrated within the chip, and the remaining (if any) modules/units can be implemented by hardware such as circuits. For each device or product applied to or integrated into a chip module, each module/unit included therein can be implemented in hardware such as circuits, and different modules/units can be located in the same component (e.g., a chip, a circuit module, etc.) or different components of the chip module, or at least some modules/units can be implemented in a software program running on an integrated processor within the chip module, and the remaining (if any) modules/units can be implemented by hardware such as circuits. For each device or product applied to or integrated into a terminal, each module/unit included therein can be implemented in hardware such as circuits, and different modules/units can be located in the same component (e.g., a chip, a circuit module, etc.) or in different components in the terminal, or at least some modules/units can be implemented in a software program running on an integrated processor in the terminal, and the remaining (if any) part of the modules/units can be implemented in hardware such as circuits.

Embodiments of the disclosure further provide a computer-readable storage medium. The computer-readable storage medium is a non-volatile storage medium or a non-transitory storage medium and stores a computer program stored thereon. The computer program, when executed by a processor, executes steps of the cross link interference measurement method provided in any of the embodiments.

Embodiments of the disclosure further provide a cross link interference measurement apparatus. The apparatus includes a memory and a processor. The memory stores a computer program executable on the processor. When executing the computer program, the processor executes steps of the cross link interference measurement method provided in the above steps 101 to 103 or the steps of the cross link interference measurement method provided in the above steps 201 to 203.

Embodiments of the disclosure solve the technical problem of a long delay of transmitting a CLI measurement result, which in turn leads to inability to effectively track dynamic configurations of subbands in subband full-duplex.

To solve the above technical problem, embodiments of the disclosure provide a CLI measurement method. The method includes: receiving CLI measurement configuration information, where the CLI measurement configuration information is contained in CSI resource configuration information, and the CLI measurement configuration information includes CLI resource configuration information and CLI measurement report configuration information; performing CLI measurement on a resource configured through the CLI resource configuration information, according to the CLI measurement report configuration information; and transmitting a CLI measurement report.

Optionally, transmitting the CLI measurement report includes: transmitting the CLI measurement report via a physical layer.

Optionally, the CLI resource configuration information includes multiple CLI measurement candidate-resource-set lists and candidate-resource-set list indication information, where the candidate-resource-set list indication information indicates a candidate-resource-set list for CLI measurement.

Optionally, the CLI resource configuration information further includes: candidate-resource-set indication information, where the candidate-resource-set indication information indicates a candidate-resource-set for CLI measurement in aperiodic transmission in the candidate-resource-set list.

Optionally, the CLI measurement report configuration information is contained in a CSI measurement report configuration.

Optionally, the CLI measurement report configuration information includes at least one of CLI reference signal received power or CLI received signal strength indicator.

Optionally, the method further includes: when transmitting the CLI measurement report, if the CLI measurement report collides with at least one of a CSI measurement report or a CQI measurement report, determining whether to transmit the CLI measurement report according to a priority of the CLI measurement report.

Optionally, the CSI measurement report has the highest priority, the CQI measurement report has the second highest priority, and the CLI measurement report has the lowest priority; or the CSI measurement report has the highest priority, the CLI measurement report has the second highest priority, and the CQI measurement report has the lowest priority.

Optionally, the priority of the CLI measurement report is determined by a user equipment, or the priority of the CLI measurement report is received from the network device.

Embodiments of the disclosure further provide another CLI measurement method. The CLI measurement method includes: generating CLI measurement configuration information, where the CLI measurement configuration information is contained in CSI resource configuration information, and the CLI measurement configuration information includes CLI resource configuration information and CLI measurement report configuration information; and transmitting the CLI measurement configuration information.

Optionally, after transmitting the CLI measurement configuration information, the method further includes: receiving a CLI measurement report via a physical layer.

Optionally, the CLI resource configuration information includes multiple CLI measurement candidate-resource-set lists and candidate-resource-set list indication information, where the candidate-resource-set list indication information indicates a candidate-resource-set list for CLI measurement.

Optionally, the CLI resource configuration information further includes: candidate-resource-set indication information, where the candidate-resource-set indication information indicates a candidate-resource-set for CLI measurement in aperiodic transmission in the candidate-resource-set list.

Optionally, the CLI measurement report configuration information is contained in a CSI measurement report configuration.

Optionally, the CLI measurement report configuration information includes at least one of CLI reference signal received power or CLI received signal strength indicator.

Optionally, the method further includes: transmitting a priority of the CLI measurement report.

Embodiments of the disclosure further provide a CLI measurement apparatus. The apparatus includes: a receiving unit configured to receive CLI measurement configuration information, where the CLI measurement configuration information is contained in CSI resource configuration information, and the CLI measurement configuration information includes CLI resource configuration information and CLI measurement report configuration information; a performing unit configured to perform CLI measurement on a resource configured through the CLI resource configuration information according to the CLI measurement report configuration information; and a first transmitting unit configured to transmit a CLI measurement report.

Embodiments of the disclosure further provide another CLI measurement apparatus. The apparatus includes: a generating unit configured to generate CLI measurement configuration information, where the CLI measurement configuration information is contained in CSI resource configuration information, and the CLI measurement configuration information includes CLI resource configuration information and CLI measurement report configuration information; and a second transmitting unit configured to transmit the CLI measurement configuration information.

Embodiments of the disclosure further provide a computer-readable storage medium. The computer-readable storage medium is a non-volatile storage medium or a non-transitory storage medium and stores a computer program stored thereon. The computer program, when executed by a processor, executes steps of any of the above methods.

Embodiments of the disclosure further provide another cross link interference measurement apparatus. The apparatus includes a memory and a processor. The memory stores a computer program executable on the processor. When executing the computer program, the processor executes steps of any of the above methods.

Compared with the prior art, the technical solutions of embodiments of the disclosure achieves the following advantageous effects.

The CLI measurement configuration information is received and the CLI measurement configuration information is contained in the CSI resource configuration information. According to the CLI resource configuration information and the CLI measurement report configuration information contained in the CLI measurement configuration information, CLI measurement is performed, to obtain the CLI measurement report. Since the CLI measurement configuration information is contained in the CSI resource configuration information, the obtained CLI measurement report can be contained in a CSI report. Upon transmission of the CSI report, the CLI measurement report can be transmitted. By transmitting the CSI report via the physical layer, the CLI measurement report can be transmitted via the physical layer. Thus, the transmission delay of the CLI measurement report can be effectively reduced, and the dynamic configurations of subbands in the subband full-duplex can be effectively tracked.

One of ordinary skill in the art will appreciate that all or part of the steps in the various methods of the above embodiments can be accomplished by a program instructing related hardware, and the program can be stored in a computer-readable storage medium, which can include ROM, RAM, magnetic disk or optical disk, etc.

Although the disclosure is disclosed as above, the disclosure is not limited thereto. Any person skilled in the art can make various changes and modifications without departing from the spirit and scope of the disclosure, and the scope of protection of the disclosure should be based on the scope defined by the claims.

1. A cross link interference (CLI) measurement method, comprising:
receiving CLI measurement configuration information, wherein the CLI measurement configuration information comprises CLI resource configuration information and CLI measurement report configuration information and the CLI measurement report configuration information is contained in a channel state information (CSI) measurement report configuration;
performing CLI measurement on a resource configured through the CLI resource configuration information, according to the CLI measurement report configuration information; and
transmitting a CLI measurement report.

2. The method of claim 1, wherein transmitting the CLI measurement report comprises: transmitting the CLI measurement report via a physical layer.

3. The method of claim 1, wherein the CLI resource configuration information comprises a plurality of CLI measurement candidate-resource-set lists and candidate-resource-set list indication information, wherein the candidate-resource-set list indication information indicates a candidate-resource-set list for CLI measurement.

4. The method of claim 3, wherein the CLI resource configuration information further comprises: candidate-resource-set indication information, wherein the candidate-resource-set indication information indicates a candidate-resource-set for CLI measurement in aperiodic transmission in the candidate-resource-set list.

5. (canceled)

6. The method of claim 1, wherein the CLI measurement report configuration information comprises at least one of CLI reference signal received power or CLI received signal strength indicator.

7. The method of claim 1, further comprising:
when transmitting the CLI measurement report, if the CLI measurement report collides with at least one of a CSI measurement report or a channel quality information (CQI) measurement report, determining whether to transmit the CLI measurement report according to a priority of the CLI measurement report.

8. The method of claim 7, wherein
the CSI measurement report has the highest priority, the CQI measurement report has the second highest priority, and the CLI measurement report has the lowest priority; or
the CSI measurement report has the highest priority, the CLI measurement report has the second highest priority, and the CQI measurement report has the lowest priority.

9. The method of claim 7, wherein the priority of the CLI measurement report is determined by a user equipment (UE), or the priority of the CLI measurement report is received from the network device.

10. A cross link interference (CLI) measurement method, comprising:
generating CLI measurement configuration information, wherein the CLI measurement configuration information comprises CLI resource configuration information and CLI measurement report configuration information and the CLI measurement report configuration information is contained in a channel state information (CSI) measurement report configuration; and
transmitting the CLI measurement configuration information.

11. The method of claim 10, wherein after transmitting the CLI measurement configuration information, the method further comprises:
receiving a CLI measurement report via a physical layer.

12. The method of claim 10, wherein the CLI resource configuration information comprises a plurality of CLI measurement candidate-resource-set lists and candidate-resource-set list indication information, wherein the candidate-resource-set list indication information indicates a candidate-resource-set list for CLI measurement.

13. The method of claim 12, wherein the CLI resource configuration information further comprises: candidate-resource-set indication information, wherein the candidate-resource-set indication information indicates a candidate-resource-set for CLI measurement in aperiodic transmission in the candidate-resource-set list.

14. (canceled)

15. The method of claim 10, wherein the CLI measurement report configuration information comprises at least one of CLI reference signal received power or CLI received signal strength indicator.

16. The method of claim 10, further comprising: transmitting a priority of the CLI measurement report.

17. (canceled)

18. (canceled)

19. (canceled)

20. A cross link interference (CLI) measurement apparatus comprising:
a transceiver;
a memory storing computer programs; and
a processor coupled with the memory and the transceiver and configured to invoke the computer programs to:
cause the transceiver to receive CLI measurement configuration information, wherein the CLI measurement configuration information comprises CLI resource configuration information and CLI measurement report configuration information and the CLI measurement report configuration information is contained in a channel state information (CSI) measurement report configuration;
perform CLI measurement on a resource configured through the CLI resource configuration information, according to the CLI measurement report configuration information; and
cause the transceiver to transmit a CLI measurement report.

21. The apparatus of claim 20, wherein the processor configured to execute the computer program to cause the transceiver to transmit the CLI measurement report is configured to execute the computer program to cause the transceiver to: transmit the CLI measurement report via a physical layer.

22. The apparatus of claim 20, wherein the CLI resource configuration information comprises a plurality of CLI measurement candidate-resource-set lists and candidate-resource-set list indication information, wherein the candidate-resource-set list indication information indicates a candidate-resource-set list for CLI measurement.

23. The apparatus of claim 22, wherein the CLI resource configuration information further comprises: candidate-resource-set indication information, wherein the candidate-resource-set indication information indicates a candidate-resource-set for CLI measurement in aperiodic transmission in the candidate-resource-set list.

24. The apparatus of claim 20, wherein the CLI measurement report configuration information comprises at least one of CLI reference signal received power or CLI received signal strength indicator.

25. The apparatus of claim 20, wherein the processor is further configured to execute the computer program to:
when transmitting the CLI measurement report, if the CLI measurement report collides with at least one of a CSI measurement report or a channel quality information (CQI) measurement report, determine whether to transmit the CLI measurement report according to a priority of the CLI measurement report.
